(19) United States
(12) Patent Application Publication
(10) Pub. No.: US 2025/0308212 A1
(43) Pub. Date: Oct. 2, 2025

(54) INFORMATION PROCESSING APPARATUS, INFORMATION PROCESSING METHOD, AND STORAGE MEDIUM

(71) Applicant: HONDA MOTOR CO., LTD., Tokyo (JP)

(72) Inventors: Kenji OKUMA, Tokyo (JP); Vikrant NAGPURE, Tokyo (JP)

(21) Appl. No.: 19/239,058

(22) Filed: Jun. 16, 2025

Related U.S. Application Data
(63) Continuation of application No. PCT/JP2023/045664, filed on Dec. 20, 2023.

(30) Foreign Application Priority Data
Dec. 22, 2022 (JP) 2022-205965

(51) Int. Cl. G06V 10/77; G06V 10/82

(52) U.S. Cl. CPC G06V 10/7715; G06V 10/82

(57) ABSTRACT

An information processing apparatus that recognizes a target or a state of the target present in an image that is captured acquires features at a plurality of resolutions of the image, extracts features to be attended to based on the features at the plurality of resolutions using a plurality of transformer encoders, and outputs the target or the state of the target as a recognition result based on output results of the plurality of transformer encoders. The apparatus extracts features to be attended to among the features at the plurality of resolutions by inputting first features at a first resolution among the features at the plurality of resolutions extracted from the image and second features at a second resolution among the features at the plurality of resolutions to a transformer encoder associated with the first resolution among the plurality of transformer encoders.

### CROSS-REFERENCE TO RELATED APPLICATION(S)

This application is a continuation of International Patent Application No. PCT/JP2023/045664 filed on Dec. 20, 2023, which claims priority to and the benefit of Japanese Patent Application No. 2022-205965 filed on Dec. 22, 2022, the entire disclosures of which are incorporated herein by reference.

### BACKGROUND OF THE INVENTION

### Field of the Invention

The present invention relates to an information processing apparatus, an information processing method, and a storage medium.

### Description of the Related Art

In recent years, techniques of using a deep neural network to recognize a state of an object or a person (referred to as a target) (for example, a posture of the target or a line-of-sight direction of the person) in an image have been proposed.

“Deep High-Resolution Representation Learning for Human Pose Estimation”, arXiv:1902.09212v1 [cs.CV], Feb. 25, 2019 proposes a technique of using a high-resolution net to recognize a human pose with higher accuracy. In the high-resolution net, information of features obtained by convolution processing in parallel high-resolution subnetwork and low-resolution subnetwork is exchanged. In the technique disclosed in “Deep High-Resolution Representation Learning for Human Pose Estimation”, arXiv:1902.09212v1 [cs.CV], Feb. 25, 2019, a human pose can be recognized with high accuracy by using such a high-resolution net.

In addition, there is known a model (Vision Transformer (ViT)) in which a transformer model exhibiting high performance as a module of a deep neural network for processing natural language data that is time-series data is applied to image processing (“Innovative Model for Image Recognition! Thorough Exposition of Vision Transformer (ViT) Having Broken Away from CNN”, [online], [searched on Oct. 19, 2022], <URL: https://deepsquare.jp/2020/10/vision-transformer/#outline_1>). In “Innovative Model for Image Recognition! Thorough Exposition of Vision Transformer (ViT) Having Broken Away from CNN”, [online], [searched on Oct. 19, 2022], <URL: https://deepsquare.jp/2020/10/vision-transformer/#outline_1>, the transformer is applied to image processing by treating an image as sequence data of a series of image patches.

### SUMMARY OF THE INVENTION

In “Deep High-Resolution Representation Learning for Human Pose Estimation”, arXiv:1902.09212v1 [cs.CV], Feb. 25, 2019 and “Innovative Model for Image Recognition! Thorough Exposition of Vision Transformer (ViT) Having Broken Away from CNN”, [online], [searched on Oct. 19, 2022], <URL: https://deepsquare.jp/2020/10/vision-transformer/#outline_1> described above, a target and a state of the target can be recognized with relatively high accuracy. However, a configuration where multi-resolution features are appropriately utilized in a transformer has not been considered.

The present invention has been made in view of the above issue, and an object thereof is to provide a technique for recognizing a target or a state of the target with high accuracy.

According to the present invention, it is possible to provide an information processing apparatus that recognizes a target or a state of the target present in an image that is captured, the information processing apparatus comprising: an acquisition unit configured to acquire features at a plurality of resolutions of the image; a feature extraction unit configured to extract features to be attended to based on the features at the plurality of resolutions using a plurality of transformer encoders; and an output unit configured to output the target or the state of the target as a recognition result based on output results of the plurality of transformer encoders, wherein the feature extraction unit is configured to extract features to be attended to among the features at the plurality of resolutions by inputting first features at a first resolution among the features at the plurality of resolutions extracted from the image and second features at a second resolution among the features at the plurality of resolutions to a transformer encoder associated with the first resolution among the plurality of transformer encoders.

According to the present invention, it is possible to provide a technique for recognizing a target or a state of the target with high accuracy.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram illustrating a functional configuration example of a vehicle according to a present embodiment;

FIG. 2 is a diagram for explaining a main configuration for a driving assistance function in the vehicle according to the present embodiment;

FIG. 3 is a diagram for schematically explaining a configuration example of a deep neural network (DNN) model of a model processing unit according to the present embodiment;

FIG. 4 is a diagram for schematically explaining a configuration example of a multi-resolution fusion transformer of the DNN model according to the present embodiment;

FIG. 5 is a diagram for schematically explaining a neural architecture search (NAS) in training the DNN model of the model processing unit according to the present embodiment;

FIG. 6 is a flowchart illustrating a series of operations of recognition processing in the model processing unit according to the present embodiment; and

FIG. 7 is a flowchart illustrating a series of operations of driving assistance processing according to the present embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Vehicle Configuration>

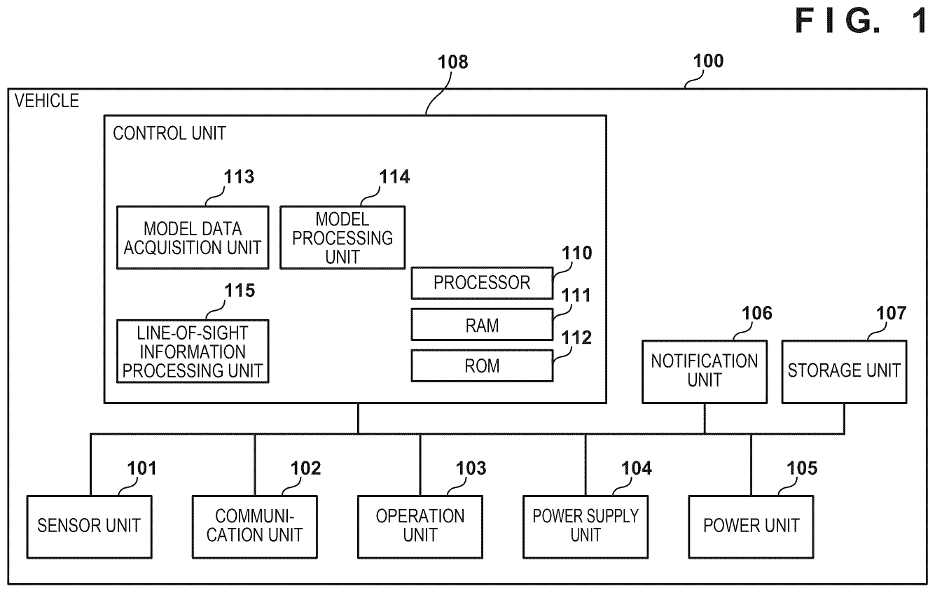

First, a functional configuration example of a vehicle 100 according to the present embodiment will be described with reference to FIG. 1. Note that each of functional blocks to be described with reference to the following drawings may be integrated or may be separated. In addition, a function to be described may be implemented in another block. Further, a functional block to be described as hardware may be implemented by software, and vice versa.

In the following example, a case where a control unit 108 is incorporated in the vehicle 100 will be described as an example, but the control unit 108 of the vehicle 100 may be configured as a control module or an information processing apparatus including a configuration of the control unit 108. That is, the present invention can be implemented as a control module or an information processing apparatus including configurations such as a processor 110 and a model processing unit 114 included in the control unit 108.

A sensor unit 101 includes a camera (an image capturing unit) that outputs a captured image of a view in front of the vehicle 100 (or views in front of, beside, and behind the vehicle). The sensor unit 101 may further include a light detection and ranging (LiDAR) that outputs a range image obtained by measuring a distance to an object in front of the vehicle (or distances to objects in front of, beside, and behind the vehicle). The sensor unit 101 further includes a camera (an image capturing unit) that is disposed inside the vehicle 100 and captures a driver's face. The captured image of the driver is used, for example, for inference processing of recognizing a target or a state of the target in the model processing unit 114. In addition, the sensor unit 101 may include various sensors that output acceleration, position information, a steering angle, and the like of the vehicle 100.

A communication unit 102 is a communication device including, for example, a communication circuit, and communicates with an information processing server 150, a surrounding transportation system, and the like via mobile communication standardized as, for example, the Long Term Evolution (LTE), LTE-Advanced, or so-called 5G standard. The communication unit 102 acquires trained parameters and the like of a learning model used by the model processing unit 114 from the external information processing server 150. In addition, the communication unit 102 receives a part or all of map data, traffic information, and the like from another information processing server or a surrounding transportation system.

An operation unit 103 includes an operation member such as a button or a touch panel installed in the vehicle 100 and members that receive input for driving the vehicle 100, such as a steering wheel and a brake pedal. A power supply unit 104 includes a battery including, for example, a lithium-ion battery, and supplies electric power to each unit in the vehicle 100. A power unit 105 includes, for example, an engine or a motor that generates power for causing the vehicle to travel.

A notification unit 106 notifies the driver with a predetermined sound such as a warning sound when a line-of-sight information processing unit 115 described below determines that a state of the driver does not satisfy a predetermined driving criterion.

A storage unit 107 includes a nonvolatile mass storage device such as a semiconductor memory. The storage unit 107 temporarily stores an actual image output from the sensor unit 101 and other various sensor data output from the sensor unit 101. In addition, the storage unit 107 stores trained parameters of a deep neural network (DNN) model executed in the model processing unit 114.

The trained parameters are received by a model data acquisition unit 113 described below from, for example, the external information processing server 150 via the communication unit 102.

The control unit 108 includes, for example, the processor 110, a random access memory (RAM) 111, and a read-only memory (ROM) 112, and controls operation of each unit of the vehicle 100. In addition, the control unit 108 acquires an image from the sensor unit 101 and executes processing in an inference stage including processing of recognizing a target or a state of the target and the like. The control unit 108 causes each unit such as the model processing unit 114 included in the control unit 108 to fulfill its function by causing the processor 110 to deploy a computer program stored in the ROM 112 to the RAM 111 and to execute the computer program.

The processor 110 includes one or more processors such as a CPU. In addition to the CPU, the processor 110 may include other processors such as a graphics processing unit (GPU) and an application specific integrated circuit (ASIC) for executing processing of the model processing unit 114 at a high speed. The RAM 111 includes a volatile storage medium such as a dynamic RAM (DRAM), and functions as a working memory of the processor 110. The ROM 112 includes a nonvolatile storage medium, and stores a computer program to be executed by the processor 110, a setting value to be used when the control unit 108 is operated, and the like.

The model data acquisition unit 113 acquires data of trained parameters of the DNN model from the information processing server 150 and stores the data in the storage unit 107. The trained parameters of the DNN model executed in the model processing unit 114 are generated by processing in a training stage of the DNN model in the information processing server 150.

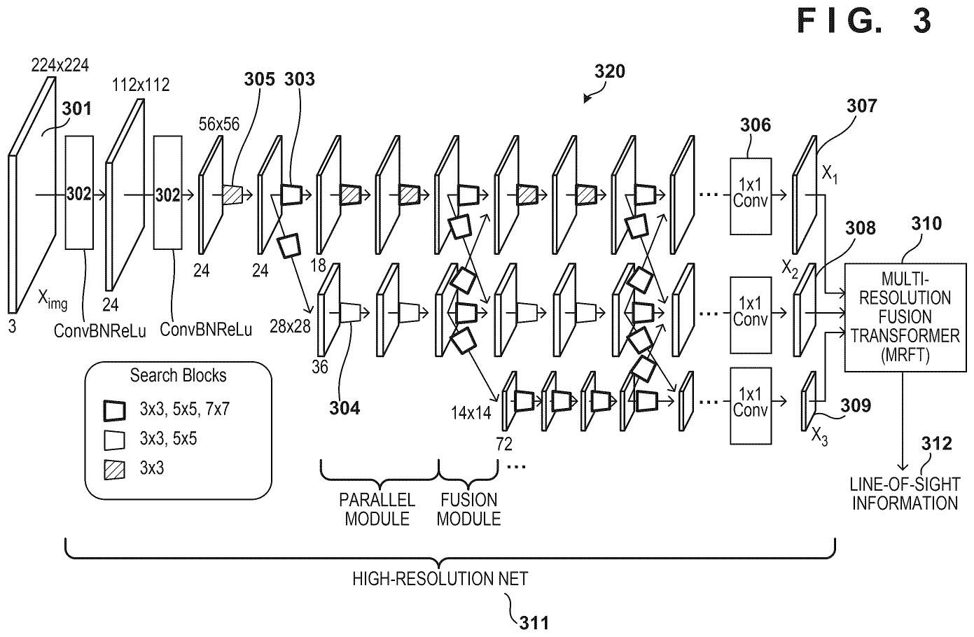

The model processing unit 114 executes the processing in the inference stage of the DNN model trained (optimized) using training data in the information processing server 150. A DNN model 320 of the present embodiment has a configuration illustrated in FIG. 3, for example.

The DNN model 320 includes a high-resolution net 311 and a multi-resolution fusion transformer (MRFT) 310. The DNN model 320 inputs an image 301 and outputs line-of-sight information. The image 301 has 224×224 pixels, for example, and includes three-channel data of RGB, for example. The line-of-sight information is information indicating a line-of-sight direction of a person present in the image 301 recognized by the DNN.

The DNN model 320 inputs the image 301 to the high-resolution net 311. The high-resolution net 311 applies feature extraction 302 including convolution to the image 301. The feature extraction 302 performs, for example, batch normalization and Relu activation after 3×3 convolution processing. When the feature extraction 302 is applied twice, features of 24 channels with a size of 56×56 (also referred to as a feature map) are obtained. Each similar plate-shaped rectangle illustrated in FIG. 3 represents features (feature map) having its size and number of channels.

Thereafter, the high-resolution net 311 repeats processing by two types of modules. Each of the two types of modules, which are a parallel module and a fusion module, includes a search block described below. Stacking search blocks in each of resolution branches allows the high-resolution net 311 to obtain a larger receptive field (wide map region) and features of a plurality of scales (region sizes). The parallel module, while repeating extraction of features at the highest resolution among a plurality of resolutions, executes extraction of features at a lower resolution among the plurality of resolutions in parallel. The fusion module is disposed after the parallel module and exchanges information across the plurality of resolution branches.

The search blocks include a first search block 303, a second search block 304, and a third search block 305. The first search block includes, for example, convolution using a 3×3 block, convolution using a 5×5 block, and convolution using a 7×7 block. The second search block includes, for example, convolution using a 3×3 block and convolution using a 5×5 block. The third search block includes, for example, convolution using a 3×3 block.

In the high-resolution net 311, the branch of features at the lowest resolution (for example, 14×14) is generated from the branch of features at a low resolution (for example, 28×28) that is higher than the lowest resolution by one level. Adjacent resolution branches are connected to each other via a search block, so that features of the respective branches can be fused. For example, features (28×28) output in the second-level branch incorporate features (56×56) input in the first-level branch, features (28×28) input in the second-level branch, and features (14×14) input in the third-level branch.

The high-resolution net 311 of the DNN model 320 gradually adds branches of features at lower resolutions and fuses information of the multi-resolution branches by using the parallel module and the fusion module.

The high-resolution net 311 reduces feature channel dimensions by applying a 1×1 Conv layer 306 that performs pointwise convolution in each resolution branch. Reducing the feature channel dimensions can reduce calculation complexity in recognition processing in a subsequent stage. The high-resolution net 311 outputs features (feature maps) 307, 308, and 309 corresponding to the respective resolution branches. The DNN model 320 inputs the features 307, 308, and 309 from the high-resolution net 311 to the multi-resolution fusion transformer 310.

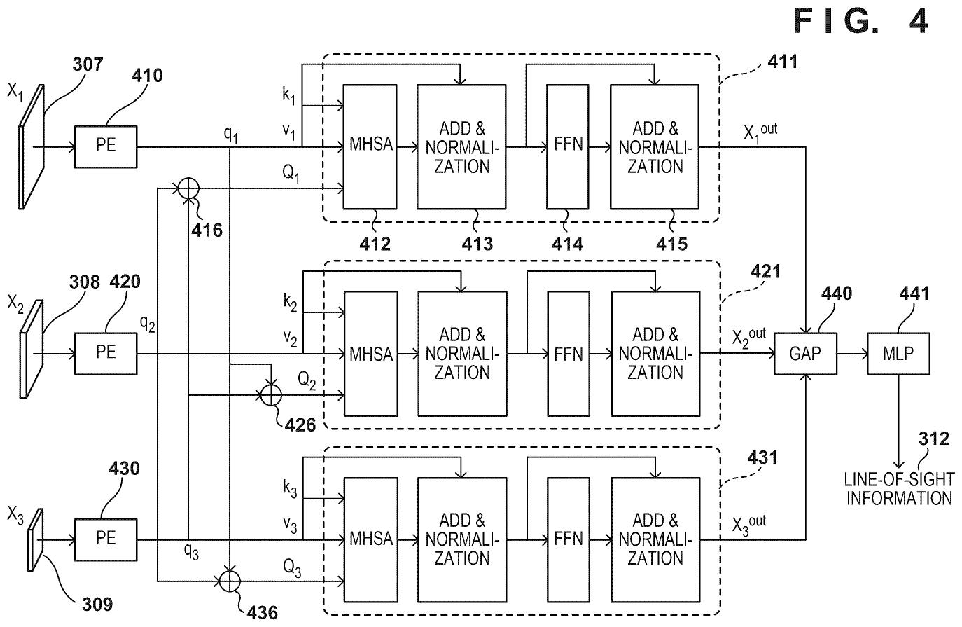

The multi-resolution fusion transformer 310 extracts features to be attended to from the respective features at the plurality of resolutions, and outputs line-of-sight information 312 including the line-of-sight direction of a person as a recognition result. A configuration of the multi-resolution fusion transformer (MRFT) 310 according to the present embodiment will be described with reference to FIG. 4. The MRFT 310 is included in the DNN model 320 configured in the model processing unit 114.

The three-resolution features 307, 308, and 309 input to the MRFT 310 are output from the high-resolution net 311 as described above. The MRFT 310 changes the sizes of the features output from the high-resolution net 311 to aggregate the features and connect the features to transformer encoders. The transformer encoder utilizes a self-attention mechanism to obtain a correlation between patches. The transformer encoder can model multi-resolution features to some extent even by simply concatenating the multi-resolution features. However, a strong correlation between different-resolution features is not satisfactorily extracted by an original transformer. Therefore, the present embodiment adopts the configuration illustrated in FIG. 4.

The MRFT 310 reshapes the all-resolution features into flattened two-dimensional patch sequences by respective PEs 410 to 430. Here, the features 307, 308, and 309 have dimensions of hᵢ×wᵢ×cᵢ. hᵢ×wᵢ denotes the resolution of the i-th features, and cᵢ denotes the number of channels of the i-th features. The two-dimensional patch sequences generated by the PEs 410 to 430 have dimensions of nᵢ×(pᵢ²·cᵢ), where pᵢ×pᵢ denotes the resolution of a feature patch. nᵢ is the number of feature patches to be generated, and satisfies nᵢ=hᵢwᵢ/pᵢ². Such a sequence of patches also functions as a valid input sequence length for the transformer encoder.

The MRFT 310 inputs the generated feature patch sequences to transformer encoders 411, 421, and 431, respectively. The transformer encoders 411, 421, and 431 each include an MHSA 412, an add & normalization 413, an FFN 414, and an add & normalization 415.

The MRFT 310 maps each flattened two-dimensional patch sequence to three matrices of feature query qᵢ, feature key kᵢ, and value vᵢ by linear transformation. Transformer queries are generated using concatenations 416, 426, and 436 to satisfy Q₁=T₁(q₂++q₃), Q₂=T₂(q₁++q₃), Q₃=T₃(q₁++q₂). Here, ++ is a concatenation operator for each channel and Tᵢ represents a conversion function. At this time, the MRFT 310 converts input to the same size as the key kᵢ. By performing such concatenation, low-resolution features are enhanced by other high-resolution features mainly including global features, and high-resolution features are provided with local information from other low-resolution features.

The MRFT 310 inputs features at a certain resolution (first features) as a key and a value of the transformer encoder, and inputs features obtained by concatenating features at the other resolutions among the plurality of resolutions (second features) as a query of the transformer encoder. This enables to extract the first features having a high correlation with respect to the second features using a modeled correlation. Sharing different-resolution features allows a result to be output efficiently in a case where there is a strong correlation between the different-resolution features.

Operations of the transformer encoders 411, 421, and 431 are represented by Equation 1.

$$\begin{matrix}[ Math . 1 ] & \\ {x}_{i}^{′} = LN ( MHSA ( {Q}_{i} , {k}_{i} , {v}_{i} ) + {x}_{i} ) & Equation 1\end{matrix}$$

$${X}_{i}^{out} = LN ( FFN ( {x}_{i}^{′} ) + {x}_{i}^{′} ) \qquad [ Math . 2 ]$$

Here, MHSA₍ᵢ₎ denotes a multi-head self-attention block, FFN denotes a feedforward network, and LN denotes a layer normalization operator. The output Xᵢ^{out} has the same matrix dimensions as the input Xᵢ. The present embodiment uses a single-layer transformer encoder. In other words, only one transformer encoder is connected in series (a plurality of transformer encoders are not connected in series with each other). The number of transformer encoders corresponds to the number of types of resolutions of the plurality of resolutions. In this way, using the single-layer transformer encoder can reduce calculation costs.

The MRFT 310 applies a global average pooling (GAP) 440 layer and a multi-layer perceptron (MLP) 441 layer to the output Xᵢ^{out}, thereby finally outputting the line-of-sight information 312. The GAP 440 layer adjust the resolution of the output Xᵢ^{out} and adds the output Xᵢ^{out} together to obtain an average value. This can smooth out a singular output value. The output results of the plurality of transformer encoders are input to the MLP 441 via the GAP 440. The MLP 441 includes a plurality of neural network layers, and is trained to output the line-of-sight information 312 based on the output results.

The line-of-sight information 312 includes, for example, xy coordinate values or an xy direction angle when the center of a rectangle of a face in an image or the intermediate position between left and right eyes is set to an origin in a non-tilted case where the face in the image is looking at a capturing camera at a line-of-sight angle of 0 degrees.

Refer back to FIG. 1 for the following description. The line-of-sight information processing unit 115 executes a driving assistance function based on the line-of-sight information 312 output from the MRFT 310. The driving assistance function includes, for example, issuing a warning for driver distraction. It is determined whether a position or movement of the line of sight of the person satisfies a predetermined driving criterion. When the predetermined driving criterion is not satisfied, a notification is generated. This example is an example of the driving assistance function using the line-of-sight information output from the MRFT 310, and the driving assistance function may include another function as long as the line-of-sight information is used. In the present embodiment, the driving assistance function using the line-of-sight information can be implemented using a known technique. An example of the driving assistance function by the line-of-sight information processing unit 115 will be described below.

### <Processing of Training MRFT>

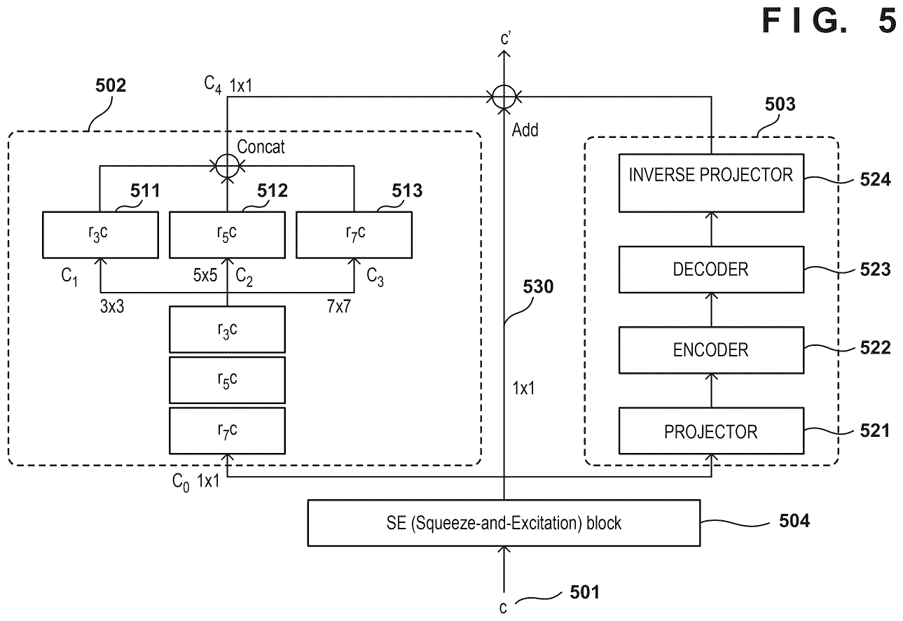

The processing in the training stage of the DNN model 320 will be described with reference to FIG. 5. In the present embodiment, a case where the processing in the training stage of the DNN model 320 is executed, for example, in the information processing server 150 will be described as an example. However, the control unit 108 in the vehicle 100 may execute the processing in the training stage of the DNN model 320.

In training of the DNN model 320, not only weight parameters of a normal neural network but also architecture parameters including hyperparameters of the DNN model and the like are searched and optimized using, for example, a neural architecture search (NAS). Note that, in the present embodiment, a case where the NAS is used for training of the DNN model 320 will be described as an example, but a method of training the DNN model 320 after determining the architecture and the hyperparameters of the DNN in advance may be used.

An exploration block in NAS includes three paths: a MixConv 502, a residual connection path 530, and a light-weight transformer 503. The light-weight transformer extracts a global context. In the present embodiment, the number of convolution channels in the MixConv 502 and the number of tokens of the light-weight transformer are searchable parameters.

In the present embodiment, exploration blocks with 3×3, 5×5, and 7×7 kernels are provided in the MixConv 502. A depthwise convolution channel or a token of the light-weight transformer is sometimes referred to as a search unit. In the example of FIG. 5, the input c 501 of the exploration block corresponds to c feature channels. A squeeze-and-excitation (SE) block 504 is applied to enhance the feature representation of the input c 501. In the path of the MixConv 502, the input channels are expanded to (r₃+r₅+r₇)c by a pointwise 1×1 convolution. Note that rᵢ denotes an expansion rate for an i×i convolution. The output is divided according to rᵢ and fed into depthwise convolutions 511 to 513 with kernel sizes of 3×3, 5×5, and 7×7, respectively. After the convolutions are performed by the convolutions 511 to 513, the outputs from all the convolutions 511 to 513 are concatenated. Another 1×1 convolution is then applied to the concatenation result, and the channels are reduced to match intended output channels c′.

In the path of the light-weight transformer 503, a projector 521 is used to project the input features with a size of c×h×w onto a reduced size of n×s×s, thereby converting the input features to the size to be input to the transformer. The projector 521 is used to reduce calculation costs. Here, n represents the number of queries, and s×s represents a reduced space size. An inverse projector 524 is applied to the output of an encoder 522 and a decoder 523 of the transformer to back-project the output onto the intended output size.

In the present embodiment, the residual connection path 530 is provided in the exploration block. The residual connection path 530 allows dealing with a case where all search units of the exploration block become zero during a search. In the residual connection path 530, a pointwise 1×1 convolution is applied to obtain the intended output size. The outputs of the MixConv 502, the light-weight transformer 503, and the residual connection path 530 are concatenated and output.

In the present embodiment, when the NAS is executed using the configuration illustrated in FIG. 5, for example, a known progressive shrinking approach can be used. In the progressive shrinking approach, the entire network is first trained, and fine tuning of the configuration such as the number of channels can be performed. In the present embodiment, by the progressive shrinking approach, the number of convolution channels and the number of transformer queries can be reduced through the processing in the training stage, and a light-weight DNN model can be generated. More specifically, training is performed using the following loss function using a penalty value weighted by the amount of calculation costs to be reduced during the training.

$$\begin{matrix}[ Math . 3 ] & \\ L = {L}_{1} ( {g}_{t} , {g}_{p} ) + λ {\sum }_{i ∈ A} {Δ}_{i} \vert {α}_{i} \vert & Equation 2\end{matrix}$$

Here, L₁ is a standard L1 loss, gₜ is a ground truth data value of the line-of-sight information, gₚ is an estimated value of the line-of-sight information, λ, is a coefficient of an L1 penalty, A is a set of all available search units, and Δᵢ is a calculation cost amount to be reduced. In the present embodiment, the NAS including the training of a DNN model is executed using the loss function according to Equation 2 to obtain an optimal DNN model.

The DNN model 320 includes a small number of transformer encoders and computational complexity reduced by optimization using the NAS as described above, so that it can be utilized for real-time line-of-sight recognition.

### <Main Configuration for Driving Assistance Function in Vehicle>

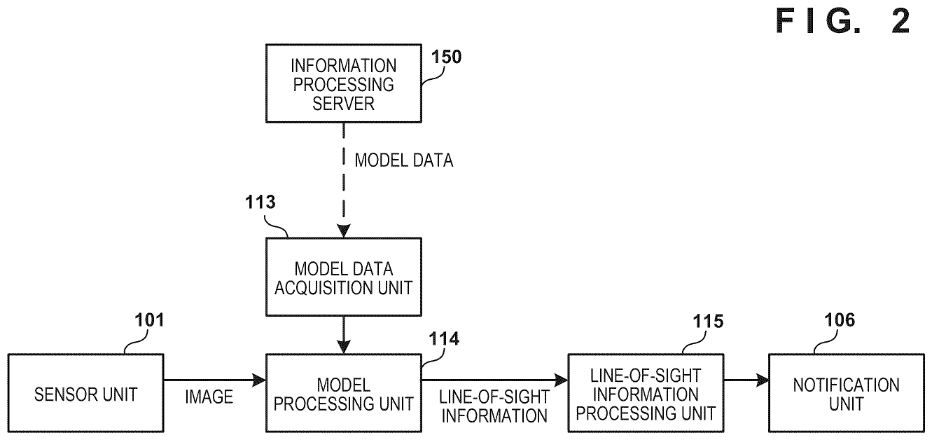

Next, a main configuration for the driving assistance function in the vehicle 100 will be described with reference to FIG. 2. The model data acquisition unit 113 of the vehicle 100 acquires the above-described trained parameters of the DNN model (weight parameters and architecture parameters optimized by training) from, for example, the information processing server 150. The acquired trained parameters are used in the model processing unit 114.

The sensor unit 101 captures the face of the driver and outputs it. The model processing unit 114 of the control unit 108 executes the above-described line-of-sight recognition processing using the image, and outputs the line-of-sight information. Further, the sensor unit 101 captures and outputs images of views in front of and beside the vehicle 100, and for example, the control unit 108 recognizes targets in the images and three-dimensional positions of the targets from the camera. The line-of-sight information processing unit 115 uses the three-dimensional positions of the targets and the line-of-sight information to specify a target at which the line of sight of the driver is directed. In a case where the target at which the line of sight of the driver is directed is a predetermined target that does not satisfy a predetermined driving criterion, or in a case where the line-of-sight direction of the driver is out of a range of the line-of-sight direction required for normal driving, the line-of-sight information processing unit 115 determines that the predetermined driving criterion is not satisfied. The notification unit 106 notifies, for example, the driver with a warning sound according to the determination made by the line-of-sight information processing unit 115.

### <Operations of Line-of-Sight Recognition Processing in Model Processing Unit>

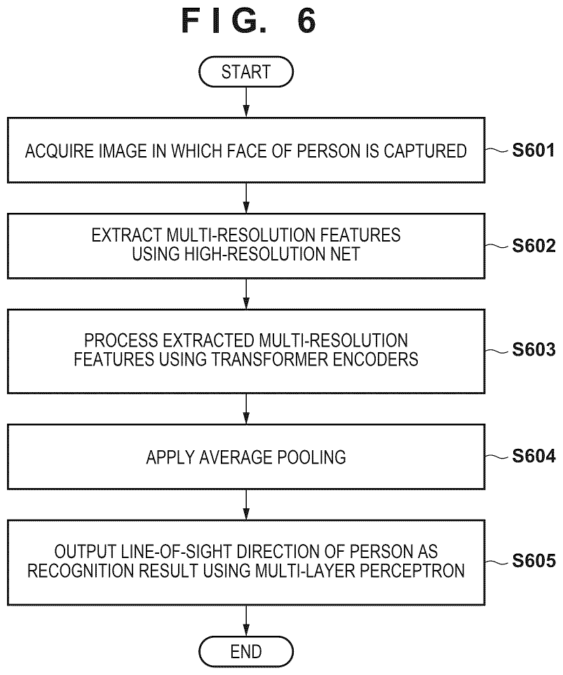

A series of operations of the line-of-sight recognition processing in the model processing unit 114 will be described with reference to FIG. 6. Note that the line-of-sight recognition processing is implemented, for example, by the processor 110 deploying a computer program stored in the ROM 112 or the storage unit 107 to the RAM 111 and executing the computer program. The model processing unit 114 performs the following processing as a processing entity unless otherwise specified.

In S601, the model processing unit 114 acquires a face image of the driver captured by the sensor unit 101. In S602, the model processing unit 114 performs the processing using the high-resolution net 311 described above to extract multi-resolution features. The model processing unit 114 outputs the above-described multi-resolution features 307, 308, and 309.

In S603, the model processing unit 114 processes the extracted multi-resolution features using the plurality of transformer encoders 411, 421, and 431. As a result, the model processing unit 114 outputs the multi-resolution output Xᵢ^{out} to which the attention processing by the transformer encoders has been applied (output with a correlation of the features taken into account).

In S604, the model processing unit 114 applies average pooling to the multi-resolution output using the GAP 440. In S605, the line-of-sight direction of the person is output as a recognition result using the MLP 441. After outputting the recognition result, the model processing unit 114 terminates the line-of-sight recognition processing.

### <Operations of Driving Assistance Processing in Vehicle>

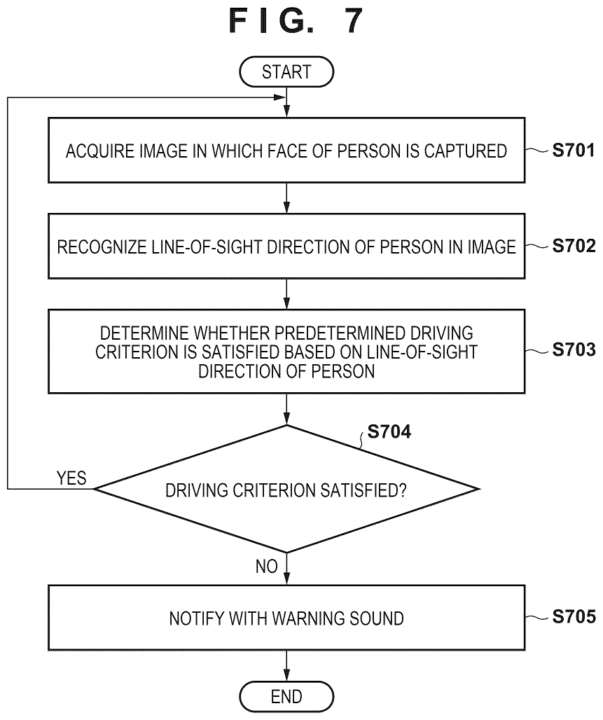

Next, operations of the driving assistance processing in the vehicle 100 will be described with reference to FIG. 7. Note that the driving assistance processing is implemented, for example, by the processor 110 deploying a computer program stored in the ROM 112 or the storage unit 107 to the RAM 111 and executing the computer program.

In S701, the sensor unit 101 acquires a captured image of the face of the person in the vehicle. In S702, the model processing unit 114 executes the above-described line-of-sight recognition processing to recognize the line-of-sight direction of the person in the image.

In S703, the line-of-sight information processing unit 115 determines whether the line of sight or a movement of the line of sight of the driver satisfies a predetermined driving criterion based on the line-of-sight direction of the person recognized by the model processing unit 114. The line-of-sight information processing unit 115 may further use captured images of views in front of and beside the vehicle 100, a recognition result of a target based on the images, distance information from the camera to the recognized target, and the like. As described above, in a case where the target at which the line of sight of the driver is directed is a predetermined target that does not satisfy the predetermined driving criterion, or in a case where the line-of-sight direction of the driver is out of a range of the line-of-sight direction required for normal driving, the line-of-sight information processing unit 115 determines that the predetermined driving criterion is not satisfied.

In S704, in a case where the line-of-sight information processing unit 115 determines that the line of sight or the movement of the line of sight of the driver satisfies the predetermined driving criterion, the processing returns to S701, and otherwise, the processing proceeds to S705. In S705, the notification unit 106 notifies, for example, the driver with a warning sound according to the determination made by the line-of-sight information processing unit 115. In this way, the driving assistance can be provided to the driver using the line-of-sight information obtained by the model processing unit 114. Thereafter, the line-of-sight information processing unit 115 terminates the driving assistance processing.

Note that, in the above-described embodiment, the case where the line-of-sight direction of a person in an image is recognized using the configuration of the above-described DNN model 320 has been described as an example. However, using the configuration of the above-described DNN model 320 allows not only recognition of the line-of-sight direction of a person but also recognition of a target or a state of the target in an image.

Further, in the above-described embodiment, the case where the model processing unit 114 in the vehicle executes the processing of the DNN model 320 has been described as an example. However, the processing of the DNN model 320 can be executed not only in the vehicle 100 but also by an external information processing server. In this case, for example, the vehicle 100 may transmit a captured image of the driver to the information processing server, and the information processing server may execute the processing of the DNN model 320 to recognize the line-of-sight direction. In other words, the processing of the DNN model 320 according to the present embodiment may be executed by the control unit 108 as an information processing apparatus, or may be executed by an information processing apparatus different from the control unit 108 mounted on the vehicle 100. Further, the processing of the DNN model 320 according to the present embodiment may be executed by the information processing server as an information processing apparatus.

Furthermore, in the above-described DNN model 320, the case of extracting features at three types of resolutions has been described as an example. However, the number of types of resolutions may be different and, for example, features at four types of resolutions may be used. However, since the calculation complexity increases as the number of types of resolutions increases, the number of types of resolutions may be four or less.

As described above, in the present embodiment, the information processing apparatus is configured to recognize a target or a state of the target present in a captured image. The information processing apparatus extracts features at a plurality of resolutions of the image, and extracts features to be attended to based on the features at the plurality of resolutions using a plurality of transformer encoders. The information processing apparatus further outputs the target or the state of the target as a recognition result based on output results of the plurality of transformer encoders. At this time, the features to be attended to among the features at the plurality of resolutions are extracted by inputting first features at a first resolution among the features at the plurality of resolutions extracted from the image and second features at a second resolution among the features at the plurality of resolutions to a transformer encoder associated with the first resolution among the plurality of transformer encoders. In this way, the target or the state of the target can be recognized with high accuracy.

The invention is not limited to the foregoing embodiments, and various variations/changes are possible within the spirit of the invention.

What is claimed is:

1. An information processing apparatus that recognizes a target or a state of the target present in an image that is captured, the information processing apparatus comprising:
an acquisition unit configured to acquire features at a plurality of resolutions of the image;
a feature extraction unit configured to extract features to be attended to based on the features at the plurality of resolutions using a plurality of transformer encoders; and
an output unit configured to output the target or the state of the target as a recognition result based on output results of the plurality of transformer encoders,
wherein the feature extraction unit is configured to extract features to be attended to among the features at the plurality of resolutions by inputting first features at a first resolution among the features at the plurality of resolutions extracted from the image and second features at a second resolution among the features at the plurality of resolutions to a transformer encoder associated with the first resolution among the plurality of transformer encoders.

2. The information processing apparatus according to claim 1, wherein the feature extraction unit is configured to input the first features as a key and a value of the transformer encoder and input the second features as a query of the transformer encoder to extract the first features having a high correlation with respect to the second features.

3. The information processing apparatus according to claim 1, wherein the feature extraction unit is configured to input features obtained by concatenating features at another plurality of resolutions among the features at the plurality of resolutions to the transformer encoder associated with the first resolution as the second features at the second resolution.

4. The information processing apparatus according to claim 1, wherein each of the plurality of transformer encoders is associated with a different resolution of the plurality of resolutions.

5. The information processing apparatus according to claim 1, wherein a number of the transformer encoders corresponds to a number of types of resolutions of the plurality of resolutions.

6. The information processing apparatus according to claim 1, wherein a number of the transformer encoders is four or less.

7. The information processing apparatus according to claim 1, wherein the plurality of transformer encoders are not connected in series with each other.

8. The information processing apparatus according to claim 1, wherein the output unit includes a network layer that is trained to output the target or the state of the target as a recognition result based on the output results of the plurality of transformer encoders.

9. The information processing apparatus according to claim 8, wherein the output unit is configured to input, to the network layer, a result obtained by applying pooling processing using an average value to an output result from each of the plurality of transformer encoders.

10. The information processing apparatus according to claim 1, wherein the target includes a face of a person, and the state of the target includes a line-of-sight direction of the face of the person.

11. The information processing apparatus according to claim 1, wherein the acquisition unit includes a second feature extraction unit configured to extract features at a plurality of resolutions of the image using a neural network.

12. The information processing apparatus according to claim 11, wherein the second feature extraction unit is configured to use a high-resolution net that, while repeating extraction of features at a highest resolution among the plurality of resolutions, performs extraction of features at a lower resolution among the plurality of resolutions in parallel and exchanges features at respective resolutions.

13. An information processing method of recognizing a target or a state of the target present in an image that is captured, the information processing method being executed in an information processing apparatus, the information processing method comprising:
acquiring features at a plurality of resolutions of the image;
extracting features to be attended to based on the features at the plurality of resolutions using a plurality of transformer encoders; and
outputting the target or the state of the target as a recognition result based on output results of the plurality of transformer encoders,
wherein extracting features includes extracting features to be attended to among the features at the plurality of resolutions by inputting first features at a first resolution among the features at the plurality of resolutions extracted from the image and second features at a second resolution among the features at the plurality of resolutions to a transformer encoder associated with the first resolution among the plurality of transformer encoders.

14. A non-transitory computer-readable storage medium comprising instructions for performing an information processing method of recognizing a target or a state of the target present in an image that is captured, the information processing method being executed in an information processing apparatus, the information processing method including:
acquiring features at a plurality of resolutions of the image;
extracting features to be attended to based on the features at the plurality of resolutions using a plurality of transformer encoders; and
outputting the target or the state of the target as a recognition result based on output results of the plurality of transformer encoders,
wherein extracting features includes extracting features to be attended to among the features at the plurality of resolutions by inputting first features at a first resolution among the features at the plurality of resolutions extracted from the image and second features at a second resolution among the features at the plurality of resolutions to a transformer encoder associated with the first resolution among the plurality of transformer encoders.
